(19) United States
(12) Patent Application Publication
(10) Pub. No.: US 2020/0234444 A1
(43) Pub. Date: Jul. 23, 2020

(54) SYSTEMS AND METHODS FOR THE ANALYSIS OF SKIN CONDITIONS

(71) Applicant: Tissue Analytics, Inc., Baltimore, MD (US)

(72) Inventors: Joshua BUDMAN, Baltimore, MD (US); Phanindra Gaddipati, Frisco, TX (US); Kevin Patrick Keenahan, Baltimore, MD (US)

(73) Assignee: Tissue Analytics, Inc., Baltimore, MD (US)

(21) Appl. No.: 16/746,138

(22) Filed: Jan. 17, 2020

Related U.S. Application Data
(60) Provisional application No. 62/794,160, filed on Jan. 18, 2019.

(51) Int. Cl. G06T 7/00; G06T 17/20; G06T 7/73

(52) U.S. Cl. CPC G06T 7/0014; G06T 17/20; G06T 2207/20081; G06T 2207/30088; G06T 7/74

(57) ABSTRACT

A system includes a first device having a non-transitory storage medium and at least one processor communicatively coupled to the non-transitory storage medium. The at least one processor is configured to receive a first set of images from a second device, each image of the first set of images including a skin condition of a patient. The at least one processor is further configured to generate a three-dimensional mesh of the skin condition based on the first set of images. The at least one processor is further configured to semantically segment boundaries of the skin condition in at least one image of the first set of images. The at least one processor is further configured to map the segmented boundaries to the three-dimensional mesh. The at least one processor is further configured to determine a depth and a volume of the skin condition based on the three-dimensional mesh.

### CROSS-REFERENCE TO RELATED APPLICATIONS

This application claims priority to U.S. Provisional Patent Application No. 62/794,160, filed Jan. 18, 2019, the entirety of which is incorporated herein by reference.

### BACKGROUND

In order to measure the status of a skin condition, such as a wound, practitioners currently rely on the use of rulers or naked eye approximations. Studies have shown that for chronic wounds these techniques have a 45% measurement error. D. Langemo et al., Measuring wound length, width, and area: which technique?, Advances in Skin & Wound Care, January 2008, 21(1): 42-45 1879-1882.

In addition, literature reports that these techniques have an inter-rater error (i.e., the error that occurs between two separate individuals measuring the same condition) of 16-50%. Gerard Koel and Frits Oosterveld, Reproducibility of Current Wound Size Surface Measurement, European Wound Management Conference Proceeding (2008). This number is particularly concerning because patients with skin conditions often have care provided for them in a variety of settings by a variety of providers. All of this makes it very difficult for providers to accurately track the longitudinal progress of these conditions.

Important parameters to measure and track while documenting wounds and other skin conditions is the depth or height of the skin condition and the concavity of the skin condition. Studies have shown that current depth measurement techniques, including the ruler-based technique for measuring depth, can be inaccurate by almost 80% compared to the ground truth depth measurement using a waterfill method. A. Shah et al., Wound Measurement Techniques: Comparing the Use of Ruler Method, 2D Imaging and 3D Scanner, J Am Coll Clin Wound Spec, December 2013, 5(3), 52-57.

Further, the use of photography in the clinical setting to document dermatology and other skin conditions is known. However, photo documentation is not widely used in the clinical setting because of the difficulty that modern clinical software systems have in managing photos.

### SUMMARY

In one aspect, a system includes a first device having a non-transitory storage medium and at least one processor communicatively coupled to the non-transitory storage medium. The at least one processor is configured to receive a first set of images from a second device, each of the first set of images including a skin condition of a patient. The at least one processor is further configured to generate a three-dimensional mesh of the skin condition based on the first set of images. The at least one processor is further configured to semantically segment boundaries of the skin condition in at least one image of the first set of images. The at least one processor is further configured to map the segmented boundaries to the three-dimensional mesh. The at least one processor is further configured to determine a depth and a volume of the skin condition based on the three-dimensional mesh.

In another aspect, a computer-implemented method includes receiving a first set of images, each of the first set of images including a skin condition of a patient. The method further includes generating a three-dimensional mesh of the skin condition based on the first set of images. The method further includes semantically segmenting boundaries of the skin condition in at least one image of the first set of images. The method further includes mapping the segmented boundaries to the three-dimensional mesh. The method further includes determining a depth and a volume of the skin condition based on the three-dimensional mesh.

In another aspect, a non-transitory computer readable medium has instructions stored thereon. The instructions, when executed by one or more processors, causes a device to perform operations including: (i) receiving a first set of images, each image of the first set of images including a skin condition of a patient; (ii) generating a three-dimensional mesh of the skin condition based on the first set of images; (iii) semantically segmenting boundaries of the skin condition in at least one image of the first set of images; (iv) mapping the segmented boundaries to the three-dimensional mesh; and (v) determining a depth and a volume of the skin condition based on the three-dimensional mesh.

### BRIEF DESCRIPTION OF THE DRAWINGS

FIG. 1 is a block diagram of an exemplary computing environment, in accordance with some embodiments.

FIG. 2 is a flowchart of an exemplary process for analyzing a skin condition in a captured image.

FIG. 3 is an exemplary skin condition and a reference object.

FIG. 4 is a flowchart of an exemplary process for analyzing a skin condition in multiple captured images.

FIG. 5 is an exemplary three-dimensional mesh of a segmented skin condition.

### DETAILED DESCRIPTION

This disclosure is not limited to the particular systems, devices and methods described herein as these may vary. The terminology used in the description is for the purpose of describing the particular version or embodiments only, and is not intended to limit the scope of the claims.

As used in this document, the singular forms “a”, “an”, and “the” include plural references unless the context clearly dictates otherwise. Unless defined otherwise, all technical and scientific terms used herein have the same meanings as commonly understood by one of ordinary skill in the art.

This description of preferred embodiments is intended to be read in connection with the accompanying drawings, which are to be considered part of the entire written description of this invention.

Systems and methods are described herein for analyzing images of a skin condition. In some embodiments, the images are analyzed to determine accurate three-dimensional measurements of the skin condition. The images and/or videos can be acquired using any appropriate device capable of capturing images, such as a smartphone. Because the methods described herein do not require the use of any special equipment by the user, cost-effective, accurate measurements of the skin condition can be achieved. The systems and methods described herein can be used to analyze a variety of skin conditions. In addition, a variety of parameters associated with the condition can be determined using the systems and methods described herein. For example, the depth of the skin condition may be automatically determined. Further, images taken at different times can be compared to monitor the progression of the skin condition.

### I. Exemplary Computing Environments

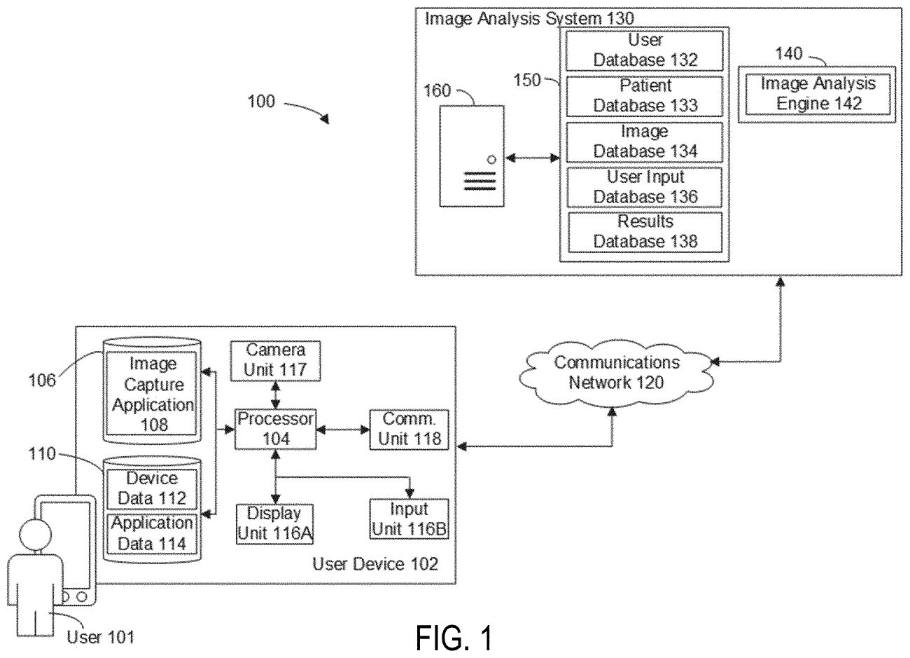

FIG. 1 is a diagram illustrating an exemplary computing environment 100 that includes an image analysis system 130 and a user device 102, each of which are operatively connected to communications network 120. Examples of network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet. Although not shown, computing environment 100 may include additional devices, such as one or more additional user devices 102, and additional network-connected computing systems, such as one or more additional image analysis systems 130.

In some embodiments, user device 102 may include a computing device having one or more tangible, non-transitory memories that store data and/or software instructions, such as application repository 106, and one or more processors, such as processor 104, configured to execute the software instructions. The one or more tangible, non-transitory memories may, in some examples, store application programs, application modules, and other elements of code executable by the one or more processors. For example, as illustrated in FIG. 1, user device 102 may maintain, within application repository 106, an executable application such as image capture application 108. Image capture application 108 may be provisioned to user device 102 by image analysis system 130, and in some instances (upon execution), may perform operations that establish a communications session with an application program executed by image analysis system 130 (e.g., an image capture and analysis session in which the user captures an image using user device 102 and, optionally, provides additional input and image analysis system 130 provides results of an image analysis operation).

Application repository 106 may also include additional executable applications, such as one or more executable web browsers (e.g., Google Chrome™), for example. For example, in various embodiments, application 108 may be a web browser that, when directed to an appropriate Web site associated with image analysis system 130, allows a user to capture and/or transmit images as described herein. The disclosed embodiments, however, are not limited to these exemplary application programs, and in other examples, application repository 106 may include any additional or alternate application programs, application modules, or other elements of code executable by user device 102.

User device 102 may also establish and maintain, within the one or more tangible, non-transitory memories, one or more structured or unstructured data repositories or databases. For example, data repository 110 may include device data 112 and application data 114. Device data 112 may include information that uniquely identifies user device 102, such as a media access control (MAC) address of user device 102 or an Internet Protocol (IP) address assigned to user device 102.

Application data 114 may include information that facilitates, or supports, an execution of any of the application programs described herein, such as, but not limited to, supporting information that enables executable application 108 to authenticate an identity of a user operating user device 102, such as user 101. Examples of this supporting information include, but are not limited to, one or more alphanumeric login or authentication credentials assigned to user 101, for example, by image analysis system 130, or one or more biometric credentials of user 101, such as fingerprint data or a digital image of a portion of user 101's face, or other information facilitating a biometric or multi-factor authentication of user 101. Further, in some instances, application data 114 may include additional information that uniquely identifies one or more of the exemplary application programs described herein, such as a cryptogram associated with application 108.

Additionally, in some examples, user device 102 may include a display unit 116A configured to present elements to user 101, and an input unit 116B configured to receive input from a user of user device 102, such as user 101. For example, user 101 may provide input in response to prompts presented through display unit 116A. By way of example, display unit 116A may include, but is not limited to, an LCD display unit or other appropriate type of display unit, and input unit 116B may include, but is not limited to, a keypad, keyboard, touchscreen, fingerprint scanner, voice activated control technologies, stylus, or any other appropriate type of input unit.

Further, in some examples, the functionalities of display unit 116A and input unit 116B may be combined into a single device, such as a pressure-sensitive touchscreen display unit that can present elements (e.g., a graphical user interface) and can detect an input from user 101 via a physical touch. User device 102 may also include a communications unit 118, such as a wireless transceiver device, coupled to processor 104. Communications unit 118 may be configured by processor 104, and can establish and maintain communications with communications network 120 via a communications protocol, such as WiFi, Bluetooth, NFC, a cellular communications protocol (e.g., LTE, CDMA, GSM, etc.), or any other suitable communications protocol.

As described herein, user device 102 may execute a locally maintained application program, such as image capture application 108, that may cause user device 102 to generate and render a digital interface for presentation on a corresponding display unit, such as display unit 116A. In some instances, the digital interface may be associated with an exchange of data, such as a data exchange with image analysis system 130, capable of initiation by the executed application program. The exchange of data may include one or more images exchanged between user 101 and image analysis system 130.

User device 102 may further include a camera unit 117. Camera unit 117 may be configured to capture pictures and/or videos. Camera unit 117 may be, for example, a camera on a smart phone. In other embodiments, camera unit 117 may be a separate camera, such as a digital camera, that is connected to, for example, a desktop computer. In some embodiments, camera unit 117 can be operated directly via application 108 running on user device 102 to capture still images and/or videos of the subject. In some embodiments, application 108 may provide guidance to the user for capturing the still images or videos. For example, application 108 may provide guidance on the optimal or acceptable distance between camera unit 117 and the subject. Application 108 may also provide guidance on the orientation of the subject or camera unit or the lighting of the image.

Examples of user device 102 may include, but are not limited to, a personal computer, a laptop computer, a tablet computer, a notebook computer, a hand-held computer, a personal digital assistant, a portable navigation device, a mobile phone, a smartphone, a wearable computing device (e.g., a smart watch, a wearable activity monitor, wearable smart jewelry, and glasses and other optical devices that include optical head-mounted displays (OHMDs)), an embedded computing device (e.g., in communication with a smart textile or electronic fabric), and any other type of computing device that may be configured to store data and software instructions, execute software instructions to perform operations, and/or display information on an interface module, consistent with disclosed embodiments. In some instances, user 101 may operate user device 102 and may do so to cause user device 102 to perform one or more operations consistent with the disclosed embodiments.

Referring back to FIG. 1, image analysis system 130 may represent a computing system that includes one or more servers 160 and tangible, non-transitory memory devices storing executable code and application modules. Further, the one or more servers 160 may each include one or more processor-based computing devices that may be configured to execute portions of the stored code or application modules to perform operations consistent with the disclosed embodiments. Additionally, in some instances, image analysis system 130 can be incorporated into a single computing system. In other instances, image analysis system 130 can be incorporated into multiple computing systems.

For example, image analysis system 130 may correspond to a distributed system that includes computing components distributed across one or more networks, such as communications network 120, or other networks, such as those provided or maintained by cloud-service providers (e.g., Google Cloud™, Microsoft Azure™, etc.). In other examples, also described herein, the distributed computing components of image analysis system 130 may collectively perform additional, or alternate, operations that establish an artificial neural network capable of, among other things, adaptively and dynamically processing images. The disclosed embodiments are, however, not limited to these exemplary distributed systems, and in other instances, image analysis system 130 may include computing components disposed within any additional or alternate number or type of computing systems or across any appropriate network.

As described herein, image analysis system 130 may also be configured to provision one or more executable application programs to network-connected devices operated by users, such as, but not limited to, executable image capture application 108 provisioned to user device 102.

To facilitate performance of these and other exemplary processes, such as those described herein, image analysis system 130 may maintain, within one or more tangible, non-transitory memories, one or more databases 150. For example, a user database 132 may include data records that identify and characterize one or more users of image analysis system 130, e.g., user 101. For example, and for each of the users, the data records of user database 132 may include a corresponding user identifier (e.g., an alphanumeric login credential assigned to user 101 by image analysis system 130), and data that uniquely identifies one or more devices (such as user device 102) associated with or operated by that user 101 (e.g., a unique device identifier, such as an IP address, a MAC address, a mobile telephone number, etc., that identifies user device 102).

Further, the data records of user database 132 may also link each user identifier (and in some instances, the corresponding unique device identifier) to one or more elements of profile information corresponding to users of image analysis system 130, e.g., user 101. By way of example, the elements of profile information that identify and characterize each of the users of image analysis system 130 may include, but are not limited to, a full name of each of the users and contact information associated with each user, such as, but not limited to, a mailing address, a phone number, or an email address. In other examples, the elements of profile data may also include values of one or more demographic characteristics exhibited by or associated with corresponding ones of the users, such as, but not limited to, an age, a gender, a profession, a job title, an associated healthcare institution, or a level of education characterizing each of the users of image analysis system 130.

A patient database 133 may include data records associated with one or more patients whose information has been entered into image analysis system 130 (e.g., by user 101 via user device 102). For example, patient database 133 may include a patient's name, age, height, weight, medication history, etc. The information stored in patient database 133 can further include skin (i.e., dermatological) conditions that the patient has previously been diagnosed with. In some embodiments, image analysis system 130 is integrated with or in communication with an electronic medical records system.

An image database 134 may include one or more images provided to the image analysis system 130 by users of the image analysis system 130 (e.g., user 101). For example, the image database 134 may include one or more images of one or more patient's skin conditions. Each image may be associated with a patient, for example using a unique patient ID number, that has a record in patient database 133.

A user input database 136 may include one or more records provided to the image analysis system 130 by users of the image analysis system 130 (e.g., user 101). For example, the records in user input database 136 may include information about a patient's skin condition that is not possible to capture from an analysis of a digital image. For example, this data may include but is not limited to drainage of the skin condition, odor emanating from the skin condition, and pain experienced by the subject. The information in the input database 136 can be cross-referenced, or mapped, to records in the patient database 133 and/or the image database 134.

An analysis results database 138 may include one or more records generated by image analysis engine 142. For example, this may include one or more dimensions associated with a skin condition (e.g., depth or volume of the skin condition). In addition, analysis results database 138 may include data regarding changes in a skin condition over time. The records in results database 138 can be cross-referenced, or mapped, to records in the patient database 133 and/or image database 134.

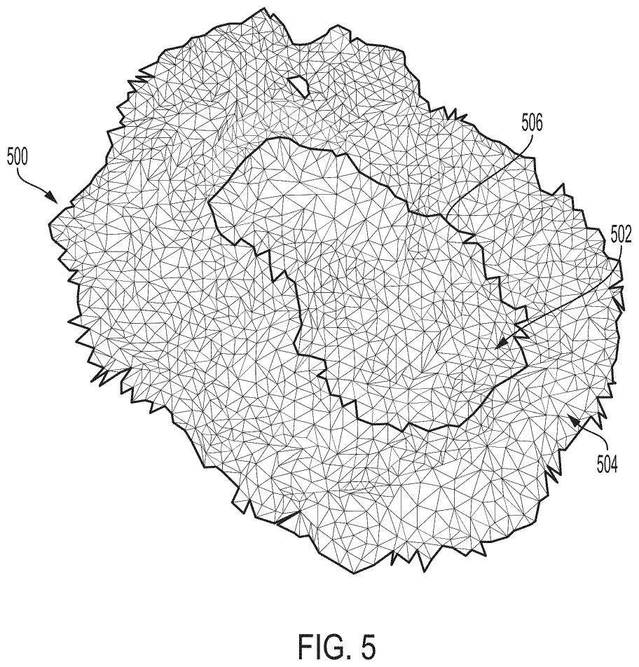

Image analysis system 130 may also maintain, within the one or more tangible, non-transitory memories, one or more executable application programs 140, such as, but not limited to, an image analysis engine 142. When executed by image analysis system 130 (e.g., by the one or more processors of image analysis system 130), image analysis engine 142 may perform any of the operations described herein to analyze images to determine, for example, the size or extent of a skin condition of a patient. For example, the image analysis engine 142 can generate a three-dimensional (3D) mesh of a skin condition and the surrounding tissue shown in the images (see FIG. 5). The image analysis engine 142 can further semantically segment the boundaries of the skin condition and map the semantically segmented boundaries to the 3D mesh to allow for the determination of the depth, volume and/or other dimensions of the skin condition. The image analysis engine 142 can further compare skin conditions in images taken at different times to determine the progression of the skin conditions. The results of the analysis can be stored in the results database 138, for example.

### II. Exemplary Computer-Implemented Processes for Analyzing an Image to Determine the Size or Extent of a Skin Condition

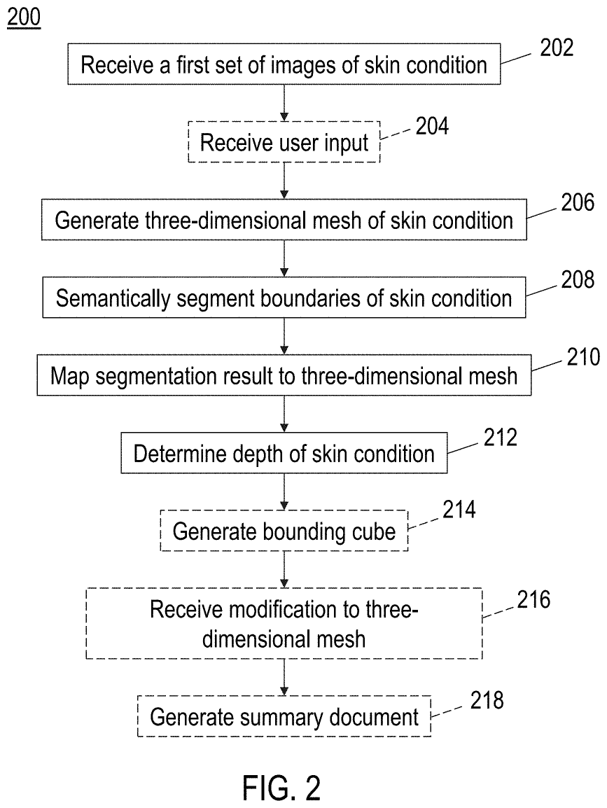

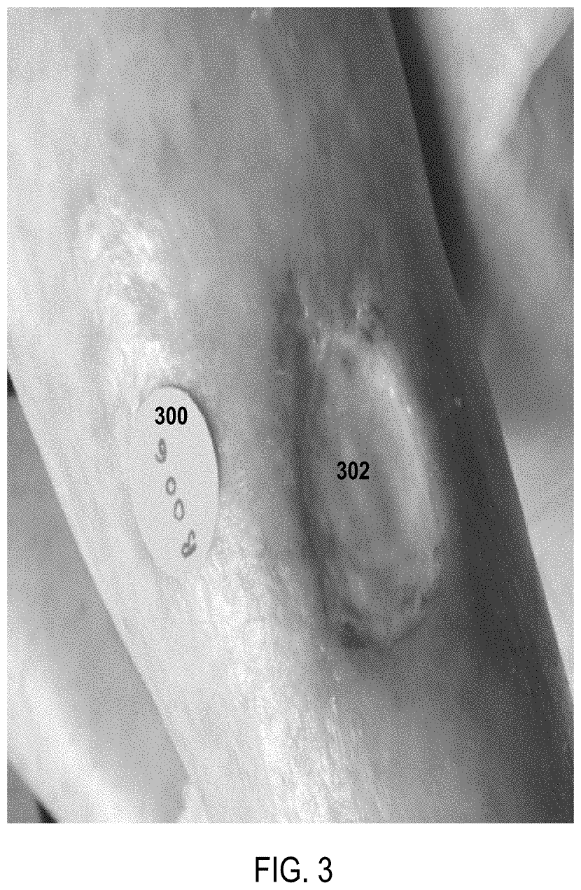

FIG. 2 shows the steps of a method 200 of analyzing a skin condition (e.g., skin condition 302 shown in FIG. 3). At step 202, a set of images of the skin condition is acquired from a user device (e.g., user device 102). In some instances, the set of images are frames of a video captured by a user. As described above, the images and/or video can be captured with any appropriate device (e.g., smartphone, tablet, laptop, digital camera, etc.). In various embodiments, an application (e.g., image capture application 108) running on the device is used to capture the images or video. The captured images and/or video are provided to image analysis system 130 and to image analysis engine 142 (e.g., via network 120). The images and/or video can be stored in image database 134.

Optionally, at step 204, the image analysis system 130 receives user input from the user (e.g., user 101) regarding the skin condition. For example, the user can provide information related to the location of the skin condition on the subject. In various embodiments, the user may provide the user input using the same device used to capture the image or video (e.g., using input unit 116B of user device 102). In other embodiments, a second device is used to provide the user input. In various embodiments, the device includes an input unit (e.g., input unit 116B) that may be a touch-screen interface. An application (e.g., image capture application 108) may provide an avatar of the subject to the user (e.g., on display unit 116A). In such embodiments, the user may indicate the location of the skin condition by touching the avatar and the anatomical position corresponding to the skin condition. In addition, these inputs may include aspects of the skin condition that cannot be collected from the digital image itself. This information may include but is not limited to drainage of the skin condition, odor and pain that the patient is experiencing as a result of, or in connection with, the skin condition. The user inputted data can be stored in user input database 136 of image analysis system 130.

At step 206, a series of images, possibly including but not limited to still images and images extracted from frames of a video, are analyzed and processed, for example, by image analysis engine 142. In various embodiments, all of the images received at step 202 are analyzed. In other embodiments, a subset of the images received at step 202 are analyzed. In various embodiments, techniques are used to generate a three-dimensional mesh (e.g., a triangular mesh) of the skin condition and the region surrounding the skin condition shown in the images. FIG. 5 shows an exemplary three-dimensional mesh 500 of a skin condition 502 and surrounding tissue 504. It should be understood that FIG. 5 is provided for purposes of illustration and the topography of the skin condition 502 and the surrounding tissue 504 may be simplified for ease of illustration. Further, it should also be noted that the density of the mesh 500 may be finer (i.e., smaller voxels or elements) or coarser (i.e., larger voxels or elements) than what is shown in FIG. 5. In one embodiment, salient feature detection and device motion is used in the generation of a 3D mesh of the scene (e.g., the skin condition and surrounding tissue). Because multiple images are provided, the changes in viewing angle and position of the skin condition in the images allows for the scene (e.g., the skin condition and surrounding tissue) to be meshed in three dimensions. Features that can be used for feature matching include, but are not limited to, histogram of oriented gradients (HoG) and speeded up robust features (SURF), as well as other known feature sets. In addition, techniques are used to reconstruct the scene in a world coordinate system. The world coordinate system is a non-oriented, arbitrary coordinate system that presents a 3D mesh in a manner that closely represents its real-world appearance. Transformation to world coordinates is performed to allow the 3D mesh to be clearly understood by end users. The reconstruction can utilize Exif tags (e.g., device GPS coordinates) associated with the images and/or videos (e.g., based on the location of user device 102 when the image is captured). In various embodiments, the reconstruction may use the salient features detected within the images and/or video. The image analysis may be performed by image analysis engine 142, shown in FIG. 1.

At step 208, the boundaries of the skin conditions in the image and/or video are semantically segmented as shown in FIG. 5 by boundary 506. Any appropriate technique for semantically segmenting the boundaries may be used. The semantic segmentation may be performed automatically by image analysis engine 142, for example. The semantic segmentation may be performed in a fully automated fashion using, for example, machine learning models generated using a large image data set. In various embodiments, ground truth for each reference image (i.e., the actual location of the boundaries) is provided by at least one clinical end user (e.g., user 101). For example, image analysis engine 142 may perform the semantic segmentation using machine learning models and based on images stored in image database 134. Hence, with each additional image added to image database 134, the accuracy of the machine learning may be improved. In various embodiments, the image features are used in semantically segmenting the boundaries of the skin condition.

At step 210, the two dimensional segmentation result is mapped to the three-dimensional mesh produced during the aforementioned 3D mesh construction step (step 206). FIG. 5 shows the boundary 506, developed at step 208, mapped to the three-dimensional mesh 500, constructed at step 206. In various embodiments, one or more of the originally captured images or frames with which to associate the segmentation result is chosen based on a salient feature matching procedure. By effectively isolating the skin condition within the 3D reconstruction of the scene, this mapping allows the depth and volume (as well as other dimensions) of the skin condition to be determined (at step 212). In various embodiments, the feature mapping procedure is performed using a hybrid of standard image feature types, including but not limited to histogram of oriented gradients (HoG), scale-invariant feature transform (SIFT) and speeded up robust features (SURF). In various embodiments, weighting of feature types is determined by optimizing results on a previously gathered image-video paired data set of skin conditions.

Optionally, at step 214, a three-dimensional bounding box (“bounding cube”) oriented to match the world coordinate representation of the 3D mesh is generated enclosing the skin condition. The bounding cube may be generated automatically by the image analysis system 130 (e.g., by image analysis engine 142). In various embodiments (as shown in FIG. 3), a reference marker 300 is included in one or more of the images and/or videos. This allows for a measurement of the real world dimensions of the bounding cube and/or the skin condition. The measurements of the bounding cube provide users with the length, width and depth of the skin condition. Further, by filling holes in the three-dimensional mesh (e.g., mesh 500) and making said three-dimensional mesh (e.g., mesh 500) watertight, an accurate volume per each mesh voxel can be calculated. Summing the volume of each voxel (i.e., adding the volume of each voxel to calculate the total volume) will provide an accurate volume calculation for the skin condition. In various embodiments, these measurements may be generated by image analysis system 130 and provided to user 101 via display unit 116A.

FIG. 3 shows an exemplary skin condition 302 to be analyzed using the systems and methods described herein and a reference object 300. Reference object 300 allows for distance normalization due to the unchanging size of the reference object 300. Knowing both the relative size of the skin condition 302 and the size of reference object 300 in the acquired image, the true size of the skin condition 302 can be calculated by dividing the pixels within the skin condition 302's mask, mesh, or bounding box by the pixels within the reference object 300's mask and multiplying this ratio by the true size of the reference object 300 such as is done in digital planimetry. In various embodiments, ray tracing may be used to allow the algorithm to generate an appropriate ratio of the real world size of reference object 300 to the 3D mesh of the reference object generated at step 206. In various embodiments, this is used to produce an accurate reference for the semantic segmentation described above. Additional methods for determining the size of the skin condition 302 using reference object 300 are described in U.S. Patent Application Publication No. 2018/0279943, entitled “System and method for the analysis and transmission of data, images and video relating to mammalian skin damage conditions,” which is incorporated by reference herein in its entirety.

At step 216, the three-dimensional mesh may optionally be manipulated by the user. For example, the user may manipulate the mesh to more accurately represent the contours of the skin condition. The user can manipulate this mesh using a computerized mouse or haptic controls (e.g., input unit 116B). In various embodiments, the mesh is displayed on a touch-screen interface and the user may manipulate the mesh by touching the screen. The user can provide the modifications to the 3D mesh prior to mapping the segmented boundaries to the 3D mesh. Alternatively, the image analysis engine 142 can re-map the boundaries to the 3D mesh after the mesh is modified by the user.

Optionally, at step 218, a summary document is generated by image analysis system 130 (e.g., by image analysis engine 142). The summary document may be provided to the user by display on user device 102 (e.g., by display on display unit 116A). Alternatively, the summary document may be e-mailed to one or more e-mail addresses. The user also has the opportunity to report patient treatment information, patient skin condition characteristics and any other notes. For example, a “Send Report” button may be provided on display unit 116A and the user may select the button using input unit 116B. For example, the patient information and results of the analysis of the skin condition (e.g., the depth and volume of the skin condition) may be compiled into a Portable Document Format (PDF) document and emailed automatically to specified email addresses.

In various embodiments, the computing environment 100 described herein can be used to collect and store a large volume of general dermatology images and analyze skin conditions in images taken across a span of time. For example, the images can be captured using user device 102 and/or other user devices associated with user 101 or other users. The captured images can be provided to image analysis system 130 and stored in image database 134. Each image stored in image database 134 can be associated with a particular patient, for example by a patient ID. In various embodiments, loss-less resizing of the images in image database 134 combined with appropriate communication between image database 134 and patient database 133 allows for images to be rapidly accessed by user device 102. In various embodiments, the patient ID does not include personally identifiable information

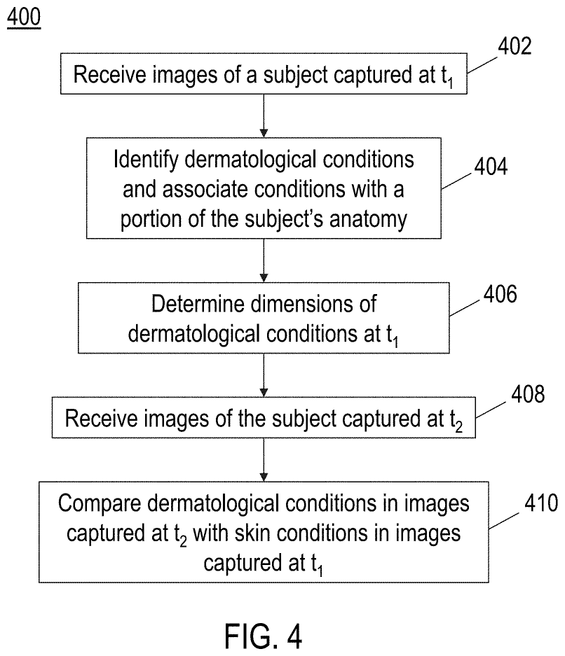

For example, in one embodiment, and as shown in FIG. 4, a method 400 includes a step 402 of acquiring a plurality of images of a subject at a first time t₁. The images can be captured in any appropriate method, for example using user device 102. The images can be securely stored in image database 134 such that the images are not accessible without proper authorization. For example, appropriate forms of encryption and authentication (e.g., two-factor authentication) may be used.

In various embodiments, the acquired images include dermatoscope images of skin lesions. These dermatoscopy images may be associated directly with a region on the subject's anatomy, as described below.

In various embodiments, the image capture application 108 may allow user 101 to acquire images as a part of a total body photography (TBP) process. In such a process, a large number of images of a subject are captured. This allows comparison of images taken at a first time to images taken at a second time to aid in the diagnosis of skin conditions, such as melanoma. As described above, these images may be stored in image database 134 to allow for subsequent access and analysis.

At step 404, the dermatological condition may be identified and associated with a location on the subject's anatomy. This can be done by a user (e.g., user 101) using an avatar-based identification system provided to user device 102 (e.g., by image capture application 108). Alternatively, the type and location of the dermatological condition may be identified automatically by image analysis system 130 (e.g., by image analysis engine 142). In various embodiments, image analysis engine 142 may use various artificial intelligence and computer vision algorithms to properly identify the type, location, and/or size of the skin lesion. The image analysis engine 142 may be trained using various images of skin lesions in order to achieve acceptable levels of accuracy.

At step 406, the dimensions of the dermatological condition in the image(s) captured at t₁ are determined. The dimensions of the dermatological condition can be determined using any of the processes described herein, for example. By way of example, a 3D mesh can be generated of the dermatological condition in the images captured at t₁. The boundaries of the dermatological condition in the images captured at t₁ can be semantically segmented and the boundaries can be mapped to the 3D mesh. Based on the 3D mesh and the segmented boundaries, the depth, volume and/or other dimensions of the dermatological condition can be determined.

The images and analysis may be provided to user 101, for example on user device 102. For example, the user may be able to access the images and analysis using a web-based dashboard. Alternatively, the user may access the images and analysis via image capture application 108. The clinician may manually or automatically classify the lesions by their clinical label. In addition, the clinician may search and sort images of specific conditions by patient based on said clinical labels.

At step 408, additional images of the subject are captured at a time t₂ that is subsequent to t₁. This second set of images can again be acquired as part of a TBP process and can be captured, for example, by user 101 using user device 102. The interval between t₁ and t₂ can be any appropriate time, for example one year.

At step 410, the images taken at t₂ are analyzed with reference to the images taken at t₁. The analysis can be performed manually by a user (e.g., user 101) or, alternatively, can be performed automatically by image analysis engine 142. The analysis may include, for example, comparing the size of dermatological conditions in the images taken at time t₂ to determine if they have grown larger than in the images captured at time t₁. The dimensions of the dermatological conditions in the images captured at t₂ can be determined using any of the processes described herein, for example. By way of example, a 3D mesh can be generated of the dermatological condition in the images captured at t₂. The boundaries of the dermatological condition in the images captured at t₂ can be semantically segmented and the boundaries can be mapped to the 3D mesh. Based on the 3D mesh and the segmented boundaries, the depth, volume and/or other dimensions of the dermatological condition in the images captured at t₂ can be determined. The dimensions of the dermatological conditions in the images captured at t₂ can then be compared to the dimensions of the dermatological conditions in the images captured at t₁. This comparison may provide an indication of the progression of the skin lesions.

In various embodiments, user 101 (e.g., a clinician user) may provide access to the image analysis system 130 to a patient. In such an embodiment, the patient may only be able to access images of him/herself. In addition, the patient may be able to capture images of him/herself and provide them to image analysis system 130. These images may be analyzed and compared, as described above. Intervals at which the patient may access the images and analysis may be set by the clinician as well.

In addition, the image analysis system 130 may be configured to communicate with electronic medical records (EMR), for example using the fast healthcare interoperability resources (FHIR) framework. This may allow the image analysis system 130 to update patient demographic information and patient schedule information in real-time.

Alternatively, in other embodiments, the image analysis system may embed UI components directly inside the EMR using the SMART on FHIR integration framework.

In one embodiment, prior to capturing images, the point-of-care user (e.g., user 101), which may be a nurse, aid, physician or patient, can collect patient consent by reading a script and inputting their digital signature on input unit 116B. The provider can then collect patient information by updating fields provided in application 108. For example, application 108 may provide dropdown menus that contain information pertaining to the specific skin condition. This information may be stored in a database (e.g., patient database 133 and/or input database 136) and used for future patient tracking.

Optionally, in one embodiment, to give users the ability to accurately report the location of the skin condition, application 108 may provide a 3D, rotatable image of a mammalian body. In such embodiments, once an area is manually selected, the area becomes highlighted. This selection may be given a human readable label and be transmitted to image analysis system 130 and stored in user input database 136. This information may be associated with an image stored in image database 134, for example using a unique identifier.

### III. Exemplary Hardware and Software Implementations

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Exemplary embodiments of the subject matter described in this specification, such as, but not limited to, application programs 140 and image analysis engine 142, can be implemented as one or more computer programs, i.e., one or more modules of computer program instructions encoded on a tangible non-transitory program carrier for execution by, or to control the operation of, a data processing apparatus (or a computer system).

Additionally, or alternatively, the program instructions can be encoded on an artificially generated propagated signal, such as a machine-generated electrical, optical, or electromagnetic signal that is generated to encode information for transmission to a suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” refer to data processing hardware and encompass all kinds of apparatus, devices, and machines for processing data, including, by way of example, a programmable processor such as a graphical processing unit (GPU) or central processing unit (CPU), a computer, or multiple processors or computers. The apparatus, device, or system described herein can also be or further include special purpose logic circuitry, such as an FPGA (field programmable gate array) or an ASIC (application specific integrated circuit). The apparatus, device, or system described herein can optionally include, in addition to hardware, code that creates an execution environment for computer programs, such as code that constitutes processor firmware, a protocol stack, a database management system, an operating system, or a combination of one or more of them.

The computer programs described herein, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. The computer programs described herein may, but need not, correspond to a file in a file system. The programs described herein can be stored in a portion of a file that holds other programs or data, such as one or more scripts stored in a markup language document, in a single file dedicated to the program in question, or in multiple coordinated files, such as files that store one or more modules, sub programs, or portions of code. The computer programs described herein can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array), an ASIC (application specific integrated circuit), one or more processors, or any other suitable logic.

Computers suitable for the execution of the computer programs described herein include, by way of example, general or special purpose microprocessors or both, or any other kind of central processing unit. Generally, a CPU will receive instructions and data from a read only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display unit, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back end component, such as a data server, or that includes a middleware component, such as an application server, or that includes a front end component, such as a computer having a graphical user interface or a Web browser through which a user can interact with an implementation of the subject matter described in this specification, or any combination of one or more such back end, middleware, or front end components. The components of the system can be interconnected by any form or medium of digital data communication, such as a communication network. Examples of communication networks include a local area network (LAN) and a wide area network (WAN), such as the Internet.

The computing systems described herein can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure.

What is claimed is:

1. A system, comprising:
a first device, the first device including:
a non-transitory storage medium; and
at least one processor communicatively coupled to the non-transitory storage medium, the at least one processor configured to:
receive a first set of images from a second device, each image of the first set of images including a skin condition of a patient;
generate a three-dimensional mesh of the skin condition based on the first set of images,
semantically segment boundaries of the skin condition in at least one image of the first set of images,
map the segmented boundaries to the three-dimensional mesh, and
determine a depth and a volume of the skin condition based on the three-dimensional mesh.

2. The system of claim 1, wherein the at least one processor is further configured to generate a cube bounding the skin condition based on the three-dimensional mesh and the segmented boundaries.

3. The system of claim 1, wherein the at least one processor is further configured to receive an input from the second device or a third device, wherein the input is a modification of the three-dimensional mesh by a user.

4. The system of claim 1, wherein the at least one processor is further configured to:
receive a second set of images from the second device or a third device, wherein each of the second set of images includes the skin condition and is taken at a time subsequent to when the first set of images are taken,
generate a second three-dimensional mesh of the skin condition based on the second set of images,
semantically segment boundaries of the skin condition in at least one image of the second set of images,
map the segmented boundaries to the second three-dimensional mesh, and
compare dimensions of the skin condition in the second set of images to dimensions of the skin condition in the first set of images.

5. The system of claim 1, wherein the at least one processor is configured to use salient feature detection in generating the three-dimensional mesh.

6. The system of claim 1, wherein the at least one processor is further configured to orient the three-dimensional mesh in a world coordinate system.

7. The system of claim 6, wherein the at least one processor is further configured to:
receive Exif tags from the second device, and
use the Exif tags to orient the three-dimensional mesh in the world coordinate system.

8. The system of claim 7, wherein the Exif tags include global positioning system coordinates of the second device at a time the first set of images is captured.

9. The system of claim 1, wherein the images in the first set of images are dermatoscope images.

10. The system of claim 1, wherein the at least one processor is further configured to receive an input from the second device or a third device, wherein the input includes one or more of location of the skin condition on the patient, drainage of the skin condition, odor associated with the skin condition, and pain the patient is experiencing as a result of the skin condition.

11. The system of claim 1, wherein the at least one processor is configured to use machine learning in semantically segmenting the boundaries of the skin condition.

12. The system of claim 1, wherein the at least one processor is further configured to:
identify a reference object at least one image of the first set of images, and
determine dimensions of the skin condition based on the ratio of the dimensions of the skin condition to a size of the reference object.

13. The system of claim 1, wherein the first set of images are frames of a video.

14. A computer-implemented method, comprising:
receiving a first set of images, each of the first set of images including a skin condition of a patient;
generating a three-dimensional mesh of the skin condition based on the first set of images;
semantically segmenting boundaries of the skin condition in at least one image of the first set of images;
mapping the segmented boundaries to the three-dimensional mesh; and
determining a depth and a volume of the skin condition based on the three-dimensional mesh.

15. The method of claim 14, further comprising generating a cube bounding the skin condition.

16. The method of claim 14, further comprising receiving an input, wherein the input is a modification of the three-dimensional mesh by a user.

17. The method of claim 14, further comprising:
receiving a second set of images, wherein each of the second set of images includes the skin condition and is taken at a time subsequent to when the first set of images are taken;
generating a second three-dimensional mesh of the skin condition based on the second set of images;
semantically segmenting boundaries of the skin condition in at least one image of the second set of images;
mapping the segmented boundaries to the three-dimensional mesh; and
comparing dimensions of the skin condition in the second set of images to dimension of the skin condition in the first set of images.

18. The method of claim 14, further comprising orienting the three-dimensional mesh in a world coordinate system.

19. The method of claim 18, further comprising:
receiving Exif tags from the second device, wherein the Exif tags include global positioning system coordinates of the second device at the time the first image is captured; and
using the Exif tags to orient the three-dimensional mesh in the world coordinate system.

20. A non-transitory computer readable medium having instructions stored thereon, wherein the instructions, when executed by one or more processors, causes a device to perform operations comprising:
receiving a first set of images, each image of the first set of images including a skin condition of a patient;
generating a three-dimensional mesh of the skin condition based on the first set of images;
semantically segmenting boundaries of the skin condition in at least one image of the first set of images;
mapping the segmented boundaries to the three-dimensional mesh; and
determining a depth and a volume of the skin condition based on the three-dimensional mesh.
